(19) United States
(12) Patent Application Publication
(10) Pub. No.: US 2019/0205955 A1
(43) Pub. Date: Jul. 4, 2019

(54) Systems and Methods for Processing Buyer-Initiated Offer Requests in Near Real-Time

(71) Applicants: Pradnya Uday Prabhune, San Jose, CA (US); Shruti Satyavrat Prabhune, San Jose, CA (US)

(72) Inventors: Pradnya Uday Prabhune, San Jose, CA (US); Shruti Satyavrat Prabhune, San Jose, CA (US)

(21) Appl. No.: 15/857,658

(22) Filed: Dec. 29, 2017

(51) Int. Cl. G06Q 30/06; G06Q 30/02

(52) U.S. Cl. CPC G06Q 30/0611; G06Q 30/0207; G06Q 30/0206; G06Q 30/0257

(57) ABSTRACT

A system and methods to coordinate in near real-time buyer-initiated personalized offer requests for products and services. When a buyer is interested in buying a particular product or service and possibly through a specific seller, buyer specifies to the system desired details of such product, service and seller, and optional personal message. The system presents to buyer a list of available sellers who can respond to offer request. Buyer initiates a request to the system for offer from seller of interest. The system sends selected seller offer request by appending additional appropriate details that can help the seller in making a more informed decision. The seller then analyzes the offer request and related data, and taking into consideration present business and market conditions responds with an appropriate offer in near real-time. The system presents offers from sellers so that the buyer may choose one from the presented offers.

### BACKGROUND OF THE INVENTION

In retailing, a seller controls prices and offers for their products or services. A buyer is often times presented with offers irrespective of one's interest in those offers. Such offers are distributed by sellers via multiple channels such as brick-and-mortar storefront, online, direct mail, and direct sales. A buyer is bombarded with unsolicited offers through these channels. Even if buyer solicits offers from certain sellers, many times the offers received are not for the specific item a buyer is planning to purchase at that moment. Buyer has to spend a lot of time sifting through all the offers just to first find out if seller has some offer for the product or service that he or she is interested in. Manually searching through the mass-marketed offers to locate the one of interest is time-consuming and arduous.

Prior art techniques provide ability to search through such offers, but given the large number of offers across multiple sellers, products and services and myriad number of channels, it is more of a matter of chance from buyer perspective to find the one specific offer that is of interest.

Prior art also provides ability for seller to send targeted offers to buyers such as specials for birthdays or anniversaries, but a buyer receiving the targeted offer may not be interested in the offered product or service from that seller and in fact may be interested in some other product or service or from some other seller.

Often times the offer is contingent upon some conditions such as valid during certain time period, requiring certain minimum purchase amount, etc. which may not work for the buyer. So, such offers, even if targeted to certain users, are not truly personalized and not tailored from that user's perspective.

In case of purchases of certain products and services, for example purchase of tires for a car, a buyer may walk into a shop and ask if that business can make an offer for that buyer's specific needs and wants, such as a specific brand of tires. However, physically visiting a business location just to find out about a personalized offer may be prohibitive from the perspective of several factors, such as time, distance, and expense involved. Also, physically visiting multiple business locations to potentially obtain personalized offers may not be realistic for the same aforementioned reasons. In addition, buyers may be uncomfortable to walk into a shop and ask for an offer.

Further, in case of purchases of certain products and services, such as purchase of tires for a car, instead of physically visiting a shop, buyer may use alternate means such as making a phone call or contact the business via instant messaging, email, website, etc., to find out if the business can make a personalized offer. However, following-up with multiple businesses via such means may be time and resource intensive from buyer's perspective.

From a business perspective, the mass-marketed as well as targeted-but-not-adequately-personalized offers preempt sellers from optimally controlling the offers in real-time and from making adjustments based on the dynamic market conditions. For example, the buyer may be interested in a particular brand of tires today but the offer from seller may be for a different brand and/or during a different time period such as next month.

Also, even if the business is able to provide some relevant offers in cases when buyer reaches out to the seller via any of the aforesaid means regarding personalized offers, accommodating such inquiries can be demanding on the business in terms of time and resources involved. Moreover, any one-off personalized offer requests are usually not supplemented with insights such as buyer information, current market conditions and business's own operational insights at the moment in an easily comprehensible format, and this can lead to suboptimal one-off offers from business's perspective.

There are currently no systems and methods for a buyer to initiate a personalized offer request with one or multiple sellers in near real-time and in an efficient manner, and for sellers to effectively respond to such requests also in near real-time taking into consideration buyer information, market, operational and other aspects.

### BRIEF SUMMARY OF THE INVENTION

The present invention comprises of systems and methods to coordinate in near real-time buyer-initiated personalized offer requests for products and services. Near real-time in the said context refers to a reasonably short time duration, such as in seconds or minutes.

In accordance with one or more embodiments, buyers and sellers are registered with a system. The sellers setup preset offers in the system and specify their availability for responding to near real-time offer requests. When a buyer is interested in buying a particular product or service and possibly through a specific seller, the buyer specifies details of such product, service and seller as desired, specifies a personal message, if so desired, and then submits the search request to the system. The system presents to the buyer a list of available sellers who can respond to the offer request. If the buyer finds one or more sellers in the list that are of interest to him or her, then the buyer submits an offer request to the system for the sellers of interest. The system processes the request and sends the selected sellers the offer request by appending additional appropriate details that can help the seller in making a more informed decision on the offer request. The seller then analyzes the offer request and related data received from the system, and taking into consideration the present business and market conditions responds with an appropriate offer in near real-time. The system presents the offers from selected sellers so that the buyer may choose to use one or more of the presented offers.

### BRIEF DESCRIPTION OF THE DRAWINGS

The preferred embodiments of the invention will be described in conjunction with the accompanying drawings provided to illustrate and not to limit the invention, where like reference numerals indicate similar elements, and in which:

FIG. 1 illustrates an exemplary computing environment according to the present invention; and

FIG. 2 illustrates a flow chart for offer request processing from seller perspective in accordance with one embodiment of the present invention; and

FIG. 3 illustrates a flow chart for offer request processing from buyer perspective in accordance with one embodiment of the present invention; and

FIG. 4 illustrates an example of an event sequence of offer request processing in accordance with one embodiment of the present invention; and

FIG. 5 illustrates an exemplary hardware platform on which the various elements described herein may be implemented according to the present invention.

### DETAILED DESCRIPTION OF THE INVENTION

In the following explanation of many illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

The term ‘article’ is used herein to refer to a good, product or service, and in general, to an item of business. The term ‘seller’ is used herein to refer to an individual or entity that exchanges any type of article in return for payment. The term seller is also commonly referred as merchant, trader, retailer, etc. The term seller used herein also includes one or more delegates that a seller may authorize to take certain actions on seller's behalf. The term ‘buyer’ is used herein to refer to an individual or entity that makes a purchase of one or more articles from a seller. The term buyer is also commonly referred as consumer, customer, etc. The term ‘offer’ is used herein to refer to a price along with specified terms as offered by a seller to a buyer for one or more articles.

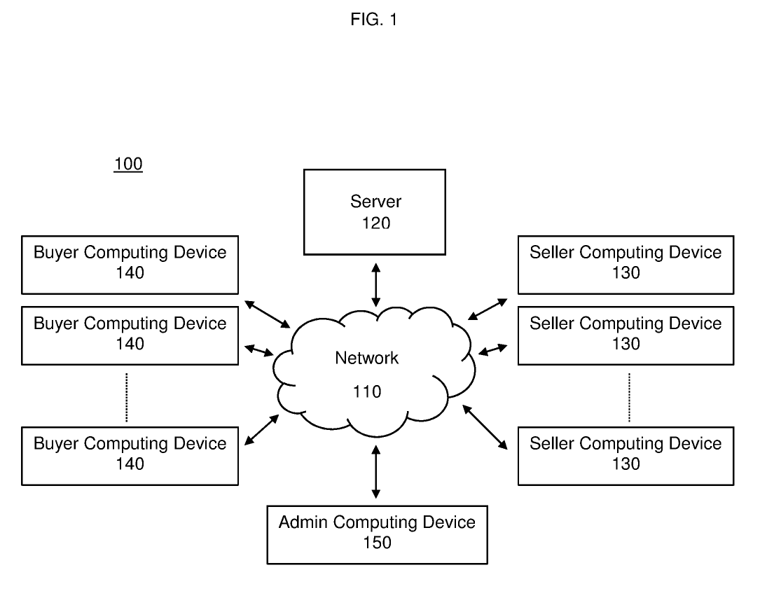

FIG. 1 illustrates an exemplary computing environment 100 according to the present invention. Network 110 represents any suitable collection of hardware, software, and controlling logic to interconnect elements coupled to network 110. Thus, network 110 provides an infrastructure to support communications between attached devices. In particular embodiments, network 110 may include one or multiple networks such as the Internet, a telecommunications network, a satellite network, a cable network, local area networks (LANs), wide area networks (WANs), and/or any other appropriate networks. As illustrated, network 110 includes one or more servers 120, one or more seller computing devices 130, one or more buyer computing devices 140, and one or more administrator (abbreviated as ‘Admin’ or ‘admin’ herein) computing devices 150.

In exemplary embodiments, one or more servers 120 may be utilized as central processing hardware for registering sellers and buyers, setting-up offer requests, generating related notifications for buyers and sellers, and processing offer requests. As used herein, the term ‘computing device,’ as in ‘seller computing device’ and ‘buyer computing device,’ refers to some electronic device, such as a mobile phone, a desktop computer, a terminal, etc. with ability to transmit and receive data via network 110. In embodiments, seller computing device 130 may execute an application program that communicates with the server 120. Using seller computing device 130, a seller may register with the server 120, setup offers, and process offer requests. In embodiments, buyer computing device 140 may execute an application program that communicates with the server 120. Using buyer computing device 140, a buyer may register with the server 120, and initiate and process offer requests. In embodiments, admin computing device 150 may execute an application program that communicates with the server 120. Using admin computing device 150, an admin may manage sellers, buyers and other aspects of offer requests. The server 120 supports capabilities to provide notifications to seller computing device 130 and buyer computing device 140. The term ‘notification’ is used herein to refer to multiple modalities of informing a seller and/or buyer, wherein the modalities include but are not limited to push notifications, pull notifications, instant text messaging, phone calls, fax, email and other. In push notifications, a server sends a message about updates to a client computing device, which has typically subscribed to updates in advance. Pull notifications are updates delivered to a client computing device in response to a user or software-initiated poll of a server.

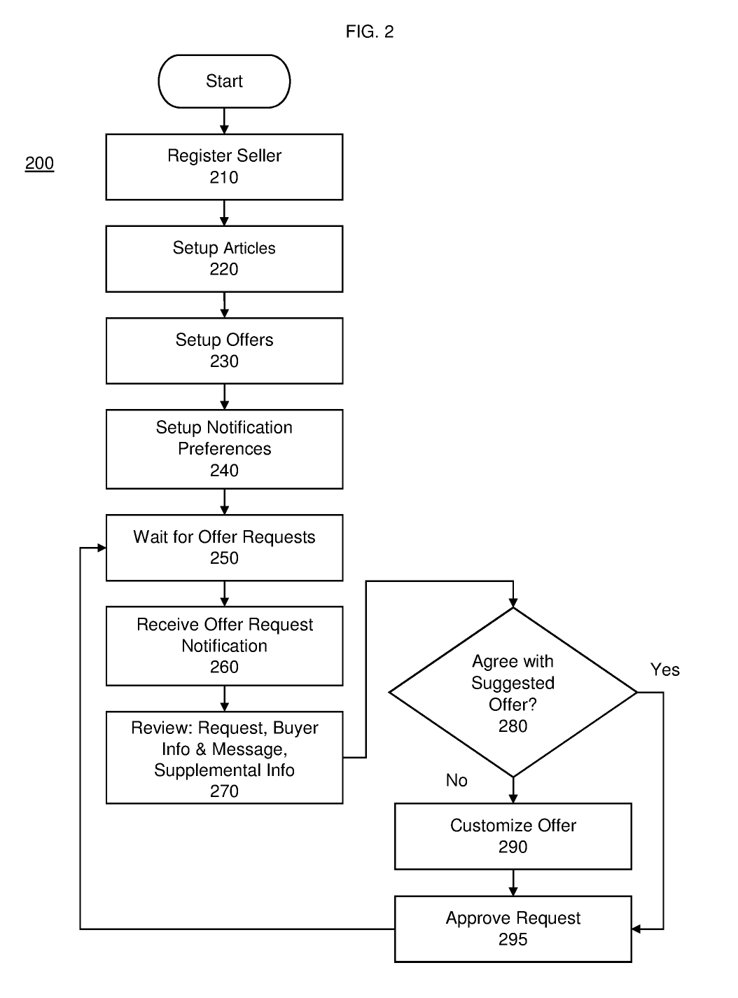

FIG. 2 illustrates a flow chart 200 for offer request processing from seller perspective in accordance with one embodiment of the present invention. As shown in FIG. 2, in step 210 seller is registered with the system. The registration may entail providing the name of the seller, address of the seller, username, password and other details as appropriate. In step 220, seller may setup one or more articles; the setup process may include providing description of the article and appropriate details such as where the article may be purchased. For example, in case of brick-and-mortar stores where the articles can be purchased by buyers, the setup for article may also include providing location information such as location name, address, open and close timings, relevant photos and/or the like. In step 230, seller may setup offer parameters so that the server 120 can automatically generate an offer in case seller does not respond to a buyer-initiated offer request in the time allocated by the server 120. The offer generated may offer article at a price that is same or lower or higher than the standard listing price of the article by the seller wherein the change in price from the standard listing price may be specified in percentage or absolute amounts. The offer may also instead or in addition to price change, offer additional incentive to the buyer, such as a free tire rotation service in case of tire purchase for an automobile. The offer parameters may include price deviation of the article from standard listing price by the seller based on parameters such as location, time of purchase, etc. In certain embodiments, the step 230 may be accomplished prior to step 220, if appropriate. Any and/or all the steps 210, 220 and 230 may be accomplished by the seller using the seller computing device 130, or by an admin using admin computing device 150 either to assist the seller or to manage the seller account. The registration may also entail enrollment of additional seller delegates who may be able to use one or more seller computing devices 130 to accomplish seller activities such as approving offer requests from buyers.

In step 240, a seller may setup the notification rules and/or preferences depending on which server 120 may take certain actions such as enabling and disabling the notifications, snoozing notifications for certain time durations, setting notification sounds and/or the like. In certain embodiments, the notifications may be configured independently for each article and/or store location as appropriate. In accordance with one embodiment of present invention, if the notifications are turned on and a buyer initiates an offer request for some article from this seller, the server 120 may send an offer request notification to the seller. If the notifications are snoozed or disabled at the time buyer initiates an offer request, the server 120 may not send an offer request notification to the seller. After the seller re-enables notifications or after the snooze time duration has elapsed, the server 120 may start sending offer request notifications to the seller. In certain embodiments, if the notifications are snoozed or disabled at the time buyer initiates an offer request, the server 120 may automatically generate offer based on offer parameters setup by the seller in step 230. The step 240 may be accomplished by the seller using the seller computing device 130 or by an admin using admin computing device 150 either to assist the seller or to manage the seller account.

In step 250, seller waits for buyer initiated offer request notifications from server 120. In step 260, seller receives an offer request notification through one or more aforementioned modalities. In certain embodiments, the seller may also be able to check on any pending offer requests, for example, to address the case when seller may have missed or not received offer request notifications.

In step 270, using seller computing device 130, seller may review the buyer initiated offer request details such as and not limited to the article of interest, buyer requirements as well as buyer information, any specific message provided by the buyer, supplemental information and suggested offer from server 120. The supplemental information may include but may not be limited to buyer's purchase history such as average spent over a selected time duration with this and/or other sellers, average rating of the buyer by sellers, offers from other sellers, article and offer inventory information, offer expiry time, etc. The supplemental information may provide additional perspective and aid seller in making a decision on the offer request. In step 280, seller analyzes the offer request and related data received from the server 120, and taking into consideration the present business and market conditions may choose to agree or disagree with the suggested offer from the server 120. If seller disagrees with the suggested offer, then in step 290 the seller may further customize the suggested offer such as increase or decrease the offered price and/or discount, offer additional incentive or reduce incentive, change offer expiry time, etc. and then proceed to approve the updated offer request in step 295. In embodiments, if seller is not interested in providing any special offer to the buyer, then the seller may choose to do so. In step 280, if seller agrees with the suggested offer from server 120, then the seller may approve the suggested offer request in step 295. In accordance with one embodiment of the present invention, if the seller doesn't approve suggested or updated offer request in step 295 within the time allocated by server 120, then the server may automatically offer the suggested offer to the buyer. After step 295, seller waits for more buyer initiated offer request notifications from server 120.

In FIG. 2, any and/or all the steps may be accomplished by the seller and/or seller's delegates using the seller computing device 130. In certain embodiments, admin may take certain actions such as updating and/or approving the offer requests using admin computing device 150 either to assist the seller or to manage the seller account.

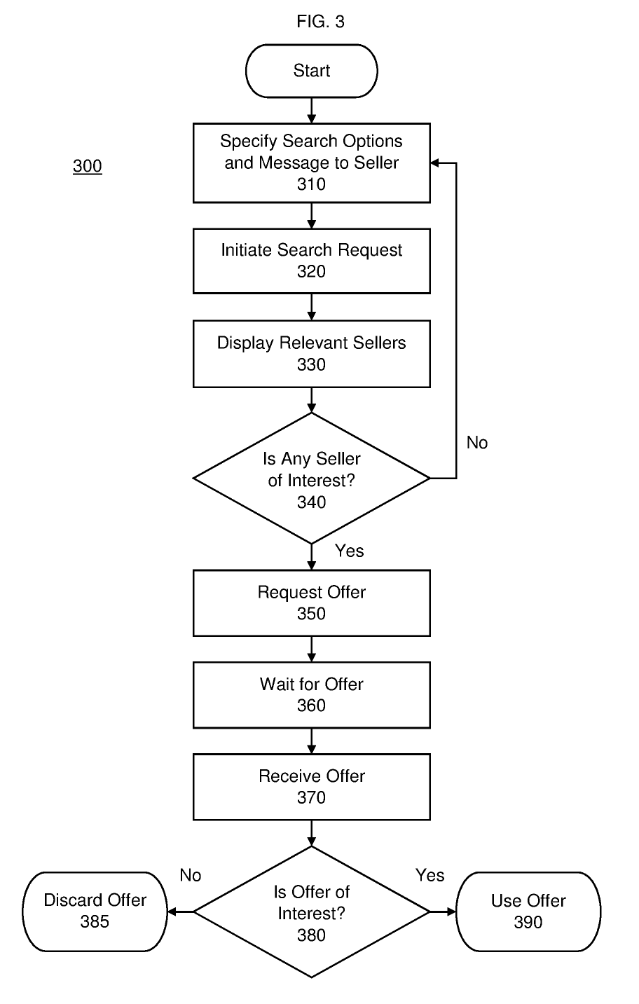

FIG. 3 illustrates a flow chart 300 for offer request processing from buyer perspective in accordance with one embodiment of the present invention. In certain embodiments, buyer may register with the system. The registration may entail providing the name of the buyer, address of the buyer, username, password and other details as appropriate. A buyer may also setup the notification rules and/or preferences depending on which server 120 may take certain actions such as enabling and disabling the notifications, snoozing notifications for certain time durations, setting notification sounds and/or the like.

In step 310, when a buyer is interested in buying a particular article and possibly through a specific seller, the buyer specifies details of the article, any specific requirements and/or options and seller as desired, specifies a personal message if so desired, and then in step 320 initiates the search request to the server 120.

In step 330, server 120 determines a list of relevant sellers who may be available to respond in near real-time to the offer request from the buyer. In embodiments, server 120 may filter the list to only include those sellers who provide certain offers such as maximum price of an article or minimum discount level as required by server 120. The buyer computing device 140 receives this list from server 120 and displays the same.

In step 340, buyer reviews the sellers in the list displayed on buyer computing device 140. If buyer doesn't find any seller of interest, then buyer may go back to step 310 and update the search options and/or message to sellers. If buyer finds one or more sellers of interest in step 340, then buyer may review each seller of interest along with article details and/or other information pertinent to the seller.

In step 350, buyer may choose to initiate an offer request to seller of interest. If buyer finds multiple sellers of interest, buyer may choose to initiate offer request to each seller individually. In certain embodiments, buyer may initiate offer requests to multiple sellers simultaneously. In embodiments, system may incorporate certain limits, such as number of offer requests in a specific time duration and/or to same sellers. The buyer computing device 140 communicates offer requests to the server 120 for further processing.

In step 360, buyer waits for sellers to respond in near real-time to the offer requests initiated in the step 350. In step 370, the buyer computing device 140 receives offer receipt notifications from the server 120 through one or more aforementioned modalities. In certain embodiments, the buyer may also be able to check on any pending offers, for example, to address the case when buyer may have missed or not received offer receipt notifications.

In step 380, buyer reviews each received offer and determines if it is of further interest to make a commitment from purchase perspective.

If the received offer is not of interest, then in step 385 buyer may proceed to discard or ignore that offer or the offer may automatically expire if the offer has an expiration time. In certain embodiments buyer computing device 140 may communicate in this regard with server 120, and then the server 120 in turn may communicate to the seller through the seller computing device 130, buyer's intent of not to use the offer.

If the received offer is indeed of interest to buyer, then in step 390, the buyer may proceed to make use of that offer. In accordance with one embodiment of the present invention, buyer may activate the offer indicating acceptance and the intent to use the offer, upon which buyer computing device 140 may communicate in this regard with server 120, and then the server 120 in turn may communicate to the seller through the seller computing device 130, buyer's intent to use the offer. The buyer may then make the actual purchase at some point later in time, or decide to cancel the activation and give-up the offer. In certain embodiments, buyer make the purchase based on the offer when it is presented in the buyer computing device 140. In certain embodiments, server 120 may facilitate buyer and seller to rate each other based on the interaction and experience they had, such as offer value, quality of the article purchased, professionalism of the seller, timeliness of the buyer, etc.

In certain embodiments in step 330, server 120 may determine a list of relevant sellers who may not be available to respond in near real-time to the offer request from the buyer as well as a list of relevant sellers who may be available to respond in near real-time to the offer request from the buyer. In case of sellers who are not available to respond in near real-time to the offer request, server 120 may automatically include an offer on behalf of seller based on preset parameters from seller in step 230 of FIG. 2. The buyer computing device 140 receives this combined list from server 120 and displays the same for the buyer. In step 340, buyer reviews the sellers in the list displayed on buyer computing device 140. If buyer is interested in the automated offer that is provided by server 120, buyer may directly proceed to step 380 and proceed with the remaining aforementioned steps. If buyer is interested in an offer from a seller who is available to respond in near real-time, buyer may proceed with the aforedescribed step 350. If buyer doesn't find any seller of interest, then buyer may go back to step 310 and update the search options and/or message to sellers.

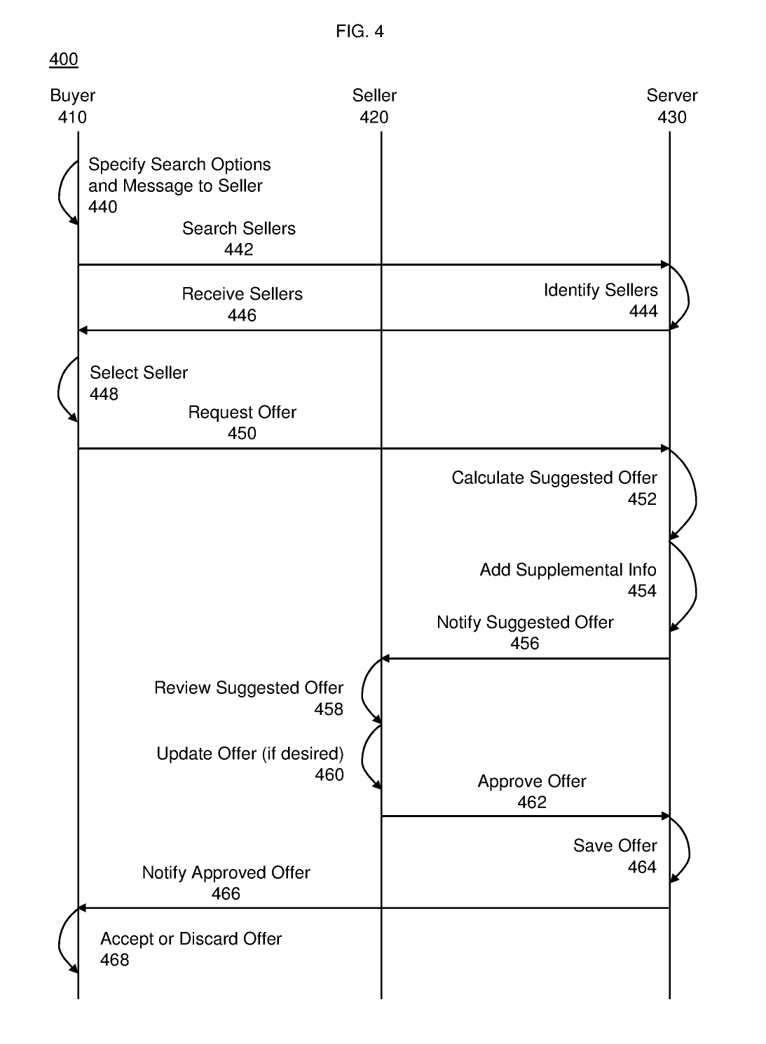

FIG. 4 illustrates an event sequence 400 which provides an example of offer request processing in accordance with one embodiment of the present invention. In the sequence diagram, actor 410 represents a buyer, actor 420 represents a seller and actor 430 represents a server. The buyer 410 uses a buyer computing device 140 of FIG. 1. The seller 420 uses a seller computing device 130 of FIG. 1. The server 430 represents the server 120 of FIG. 1. Some of the steps preceding the offer request processing, such as registration, have been covered in the descriptions of FIG. 2 and FIG. 3.

In event 440, when a buyer 410 is interested in buying a particular article and possibly through a specific seller, the buyer specifies details of the article, any specific requirements and/or options and seller as desired, specifies a personal message if so desired, and then in event 442 initiates the search request to the server 430.

In event 444, server 430 determines a list of relevant sellers who may be available to respond in near real-time to the offer request from the buyer. In event 446, the buyer computing device 140 receives this list from server 430 and displays the same for the buyer 410.

In event 448, buyer 410 reviews the sellers in the list displayed on buyer computing device 140. If buyer 410 finds one or more sellers of interest, then buyer 410 may review each seller of interest along with article details and/or other information pertinent to the seller.

In event 450, buyer 410 initiates an offer request to one or more sellers of interest and the buyer computing device 140 communicates the offer request to the server 430 for further processing.

In event 452, server 430 processes the offer request and calculates suggested offer based on the offer request details such as and not limited to the article of interest, buyer requirements and/or options as well as buyer information, and any specific message provided by the buyer. In event 454, the server 430 adds aforementioned supplemental information to the suggested offer, as appropriate. The supplemental information may provide additional perspective and aid seller 420 in making a decision on the offer request.

In event 456, server 430 notifies the seller 420 of the offer request from buyer 410 and provides the suggested offer.

In event 458, seller may review the aforementioned offer request details using seller computing device 130 and taking into consideration the present business and market conditions may choose to agree or disagree with the suggested offer from the server 120. If seller disagrees with the suggested offer, then in event 460 the seller may further customize the suggested offer such as increase or decrease the offered price and/or discount, offer additional incentive or reduce incentive, etc. and then proceed to approve the updated offer request in event 462. Also, if seller agrees with the suggested offer from server 120, then the seller may approve the suggested offer request in event 462.

In event 464, server 430 may save the offer details for future reference, such as for supporting analytics, and for sharing such information with buyer 410 and seller 420, as appropriate.

In event 466, server 430 notifies the buyer 410 of the offer receipt. The buyer 410 can then review the offer details using buyer computing device 140.

In event 468, buyer 410 may decide to accept or discard the offer. If the received offer is of interest to buyer, then the buyer may proceed to make use of that offer in the aforedescribed manner. If the received offer is not of interest, then the buyer may proceed to discard that offer.

The following is discussed with reference to a shop that sells tires for a car, but is merely exemplary, as the present invention is applicable to a variety of goods, products and services.

Bill is the owner of TireWorks, a small business selling automobile tires and related services, such as wheel alignment. TireWorks offers tires at special, discounted pricing for some brands during certain months. However, given unavailability of a suitable computing system, TireWorks is not able to offer special, individualized pricing to its customers on their computing devices over network, and at scale, and in near real-time based on individual, personal requests.

TireWorks registers with the said server and sets up the brands of tires to offer through the system. TireWorks also sets up offer parameters for tires for a given month: (1) 10% discount if 4 tires are purchased and 5% discount if 2 tires are purchased, (2) 5% discount in case of brand PQR and no discount in case of brand ABC, (3) 5% discount in case of a new customer and 3% discount in case of a repeat customer within last year, (4) 2% discount in case of customers from 3 nearby zip codes, (5) 2% additional discount if customer signs-up for wheel alignment, (6) Up to 3 offers per day. Also, seller sets up these pricing adjustments for other timings, such as next month. Seller enables notifications for receiving personalized offer request notifications from buyers.

Joe, a buyer in TireWorks's neighborhood, is interested in purchasing 4 tires of brand PQR this month. Joe is a potential new customer for TireWorks. Joe is also interested in replacing 2 tires on his other car next month. Using his smart phone, Joe specifies these details in the search request along with a message to the seller about his intent of purchasing 2 more tires next month. The server determines the list of relevant sellers who are available to respond to Joe's request. This list includes TireWorks. Joe initiates request for an offer from TireWorks. The server calculates suggested offer as 22% discount (10% for 4 tires, 5% for brand PQR, 5% since Joe is a new customer and 2% since Joe is from neighborhood zip code). The server provides this suggested offer along with supplemental information, for example, Joe's average rating with sellers and 3 offers remaining for the day. The server notifies TireWorks about the offer request from a buyer (Joe) along with suggested offer and supplemental information. Using his smartphone, Bill reviews offer request details, suggested offer and supplemental information and personal message from the buyer, and considering his business situation decides to increase the discount offered to 25% and sends his approval to the server within a minute of receiving the offer request. The server communicates this offer to Joe. Joe decides to accept the offer, and the server notifies the decision to Bill.

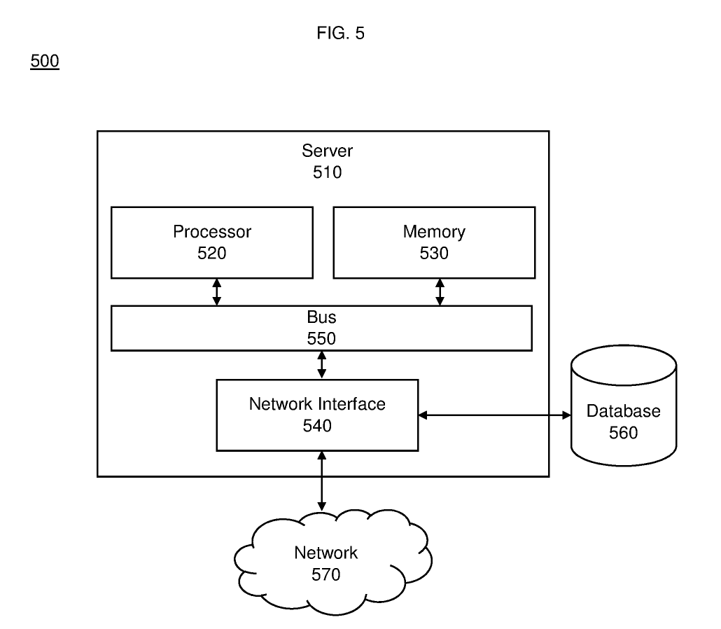

FIG. 5 illustrates general hardware elements that can be used to implement the methods according to the present invention. The exemplary server computer system 510 represents the server 120 of FIG. 1. One or more servers 510 may carry out the methods described herein as computer code. One or more processors 520, which may be general purpose processors or a special purpose processors, are connected to a bus 550. Bus 550 connects various components allowing flow of information. The processor 520 can receive computer code over the bus 550. The term ‘computer code’ used herein includes, for example, programs, instructions, and signals. The processor 550 executes computer code and may further send the computer code and data via the bus 550.

Server 510 may include one or more memories, such as memory 530, serving as a computer usable storage medium to store and/or access computer instruction code. The memories may be, for example, random access memory (RAM), read-only memory (ROM), a hard disk drive, a mass storage device, or any combination thereof.

Server 510 may further include network interface 540, that allows data or computer code to be transferred between server 510 and external devices including other computer systems through network 570. The network 570 represents the network 110 in FIG. 1. The network interface 540 includes, but is not limited to, network interface (such as Ethernet card), wired or wireless systems (such as WiFi, Bluetooth, IR), local area networks (LAN), wide area networks (WAN), intranets, etc.

Pursuant to the exemplary embodiment, the server 510 is connected to the database 560 through network interface 540 for reading and writing data therein. The database 560 stores buyers' data, sellers' data, offer data, etc.

Processor 520 executes the computer code in order to implement the methods of the present invention. As an example, the methods according to the present invention may be implemented using software that includes the computer code, wherein the software is loaded into the server 510 using memory 530, network interface 540. The computer code in conjunction with computer system 510 described herein may perform any one of, or any combination of, the steps of any of the methods presented herein. It is complemented that the methods according to the present invention may be performed automatically, or may be invoked by some form of manual intervention.

The architecture in FIG. 5 is provided only for purposes of illustration, such that the present invention is not limited to this specific embodiment. It is appreciated that a person skilled in relevant art knows how to program and implement the invention using any computer system or network architecture.

What is claimed is:

1. A method of coordinating in near real-time buyer-initiated personalized offer requests, comprising a network server, a microprocessor, a memory and computer software, said computer software being located in said memory and run by said microprocessor, said computer software comprising an offer request coordination algorithm, wherein said offer request coordination algorithm comprises the steps of:
(a) obtaining setup information of an article from seller;
(b) accepting of offer parameters provided by seller;
(c) obtaining notification preferences from seller and buyer;
(d) accepting search details for a personalized offer request from buyer;
(e) generating a list of sellers available to respond personally to offer requests in near real-time;
(f) providing information regarding said sellers to buyer;
(g) receiving buyer initiated offer request for one or more sellers;
(h) determining suggested offers for one or more sellers;
(i) notifying one or more sellers of the said offer request and said suggested offers;
(j) receiving approved offers from one or more sellers;
(k) notifying buyer about the said approved offers;
(l) receiving decisions from the buyer on the said offers; and
(m) notifying sellers of the decisions by buyer on the said offers.

2. The method of offer request coordination of claim 1, wherein said near real-time is one minute.

3. The method of offer request coordination of claim 1, wherein said near real-time is less than one minute.

4. The method of offer request coordination of claim 1, wherein said near real-time is greater than one minute.

5. The method of offer request coordination of claim 1, wherein said article is a product sold or a service provided by said seller.

6. The method of offer request coordination of claim 1, wherein said offer parameters comprise change in price of the said article by a percentage amount from standard listing price by the seller.

7. The method of offer request coordination of claim 1, wherein said offer parameters comprise change in price of the said article by an absolute amount from standard listing price by the seller.

8. The method of offer request coordination of claim 1, wherein said notification includes at least one of push notification or pull notification.

9. The method of offer request coordination of claim 1, wherein said search details include at least one of article description, article quantity, purchase time, buyer location, seller name and seller location.

10. The method of offer request coordination of claim 1, wherein said search details comprise a personal message to the seller from the buyer.

11. The method of offer request coordination of claim 1, wherein said generating a list of sellers comprises filtering the list to only include sellers providing offers with offered price of the said article below a configured maximum value.

12. The method of offer request coordination of claim 1, wherein said generating a list of sellers comprises filtering the list to only include sellers providing offers with offered discount level above a configured minimum value.

13. The method of offer request coordination of claim 1, wherein said receiving buyer initiated offer request for one or more sellers is required within a selected time interval.

14. The method of offer request coordination of claim 1, wherein said determining suggested offers for one or more sellers comprises calculating suggested pricing information of the said article for each seller.

15. The method of offer request coordination of claim 1, wherein said determining suggested offers for one or more sellers comprises adding supplemental information regarding buyer's purchase history comprising of average spent over a selected time duration.

16. The method of offer request coordination of claim 1, wherein said determining suggested offers for one or more sellers comprises adding supplemental information regarding offers from other sellers.

17. The method of offer request coordination of claim 1, wherein said determining suggested offers for one or more sellers comprises adding supplemental information regarding offer inventory information.

18. The method of offer request coordination of claim 1, wherein said receiving approved offers is required within a selected time interval.

19. The method of offer request coordination of claim 1, wherein said decision is selected from a group of accepted, canceled, and ignored.
